(19) United States
(12) Patent Application Publication
(10) Pub. No.: US 2013/0166451 A1
(43) Pub. Date: Jun. 27, 2013

(54) PAYMENT METHOD AND SYSTEM USING ELECTRONIC CARD

(71) Applicant: KT CORPORATION, Seongnam-si (KR)

(72) Inventors: Min-Gu LEE, Seongnam-si (KR); Dong-Wan KIM, Seoul (KR)

(73) Assignee: KT CORPORATION, Seongnam-si (KR)

(21) Appl. No.: 13/724,410

(22) Filed: Dec. 21, 2012

(30) Foreign Application Priority Data
Dec. 22, 2011 (KR) 10-2011-0140288

(51) Int. Cl. G06Q 20/40

(52) U.S. Cl. CPC G06Q 20/409
USPC 705/44

(57) ABSTRACT

A method and a system of payment using an electronic card is provided. The payment system in accordance with an exemplary embodiment includes an electronic card, a merchant terminal and a payment server. The electronic card obtains server authentication information from the payment server, performs server authentication by using the obtained server authentication information, and sends a payment request including payment information to the payment server according to an authentication response of the payment server. The merchant terminal mediates a message for authentication and payment between the electronic card and the payment server. The payment server performs client authentication by obtaining client authentication information from the electronic card according to the server authentication and sends the authentication response to the electronic card, and sends payment approval pursuant to the payment request to the electronic card through the merchant terminal.

### CROSS-REFERENCE TO RELATED APPLICATION

This application claims priority from Korean Patent Application No. 10-2011-0140288, filed with the Korean Intellectual Property Office on Dec. 22, 2011, the disclosure of which is incorporated herein by reference in its entirety.

### BACKGROUND

1. Technical Field

Methods and systems consistent with exemplary embodiments relate to a payment system, and, more specifically, to a method and a system for payment through mutual authentication between an electronic card and a payment server.

2. Background Art

It is very simple to read and duplicate a magnetic strip of a plastic credit card through a card reader. Consequently, there have been constant reports of various credit card hacking cases. To prevent this, there has been an attempt to introduce a credit card using a contactless smartcard, but it has been also known to be vulnerable to a man-in-the-middle (MITM) attack and the like. The fundamental cause of this kind of problem is the payment method of a passive-type credit card, which is magnetic-based or radio frequency identification (RFID)-based, in which payment is requested via a central credit approval system by having credit card information (card number, expiration date, etc.) read by a card reader.

In principle, at the moment when payment is carried out, the credit card information can be known by the card reader or can be eavesdropped by wireless communication in the case of a contactless smartcard. The seriousness of eavesdropping and hacking the smartcard can be easily understood through news reports of hacking the MIFARE RFID cards, which are popular fare cards for public transportation in Korea. Therefore, since the passive-type credit card which allows the credit card information to be assessed by the card reader is vulnerable to MITM and other attacks, it is necessary to introduce an active-type credit card that allows payment to be carried out between the credit card and the central credit approval system while the card reader is kept from knowing the credit card information.

### SUMMARY

Exemplary embodiments provide a method and a process for carrying out electronic payment using mutual authentication between an electronic card and a payment server.

Exemplary embodiments also provide a method and a system for electronic payment that can prevent card information or authentication information required for payment from being exposed in an intermediary device such as a merchant terminal that simply transfers the payment.

Accordingly, exemplary embodiments can prevent malicious hacking and/or eavesdropping at an intermediary device such as a card reader or a merchant terminal.

Furthermore, exemplary embodiments provide a method and a system for electronic payment that can apply a new authentication protocol, which may be introduced in response to new security threats, to an intermediary device, such as a card reader or a merchant terminal, which are already installed, without modifying the intermediary device.

An aspect of an exemplary embodiment features a payment system that can carry out electronic payment by use of mutual authentication between an electronic card and a payment server.

The payment system in accordance with an exemplary embodiment can include an electronic card which obtains server authentication information from a first server, to perform server authentication based on the obtained server authentication information, and sends a payment request including payment information to the first server according to an authentication response of the first server, a terminal which receives and transmits a message for authentication and payment between the electronic card and the first server; and the first server which is configured to perform client authentication by obtaining client authentication information from the electronic card according to the server authentication and send the authentication response to the electronic card, and configured to send payment approval pursuant to the payment request to the electronic card through the terminal.

The server authentication information can be at least one from among a server certificate and a first key for authentication of the first server, and the client authentication information can be authentication information generated using at least one from among a client certificate and a second key issued through one of the first server and a second server of an agency for authentication of the electronic card.

The electronic card and the first server are configured to authenticate each other by capsulizing the server authentication information and the client authentication information based on an authentication protocol that is unknown to the terminal for mutual authentication and sending the capsulized server authentication information and client authentication information through the terminal.

The electronic card can send card identification information to the first server through the terminal according to a request of the terminal, prior to the mutual authentication.

The card identification information is not a card number of the electronic card.

Another aspect of an exemplary embodiment provides a method of electronic payment by use of mutual authentication between an electronic card and a payment server.

In the method of electronic payment in a payment system, in accordance with an exemplary embodiment, the electronic card can send card identification information to a server through a terminal pursuant to a request by the terminal, and the payment server can send server authentication information to an electronic card through the terminal pursuant to receiving the card identification information and perform client authentication by obtaining client authentication information from the electronic card, and if the client authentication is successful, the server can perform a payment process and send one of a payment approval message and a payment failure message to the electronic card through the terminal.

The electronic card can send payment information in a payload when the electronic card sends the card identification information to the server.

After the performing the client authentication by the server, the electronic card can send a payment request containing payment information to the server through the terminal. Payment approval can be determined based on the payment information contained in the payment request, when electronic payment is carried out by the server.

The electronic card and the server can authenticate each other by capsulizing information sent and received for authentication based on a protocol that is unknown to the terminal.

Each of the server authentication information and the client authentication information can be generated using at least one from among a certificate and a key.

In accordance with another exemplary embodiment, there is provided a method of electronic payment in a payment system. The method comprises: receiving, at a server, card identification information through a terminal pursuant to a request by the terminal, the card identification information being sent by an electronic card; sending server authentication information to the electronic card through the terminal pursuant to receiving the card identification information and performing client authentication by obtaining client authentication information from the electronic card; and if the client authentication is successful, performing a payment process and sending one of a payment approval message and a payment failure message to the electronic card through the terminal.

The server may receive payment information in a payload with the card identification information, from the electronic card.

After the performing of the client authentication, a payment request containing payment information may be received, wherein payment approval is determined based on the payment information contained in the payment request.

The electronic card and the server authenticate each other by capsulizing information sent and received for authentication based on a protocol that is unknown to the terminal.

Each of the server authentication information and the client authentication information is generated using at least one from among a certificate and a key.

In yet another exemplary embodiment, there is provided a method of electronic payment in a payment system. The method comprising: sending, by an electronic card, card identification information to a server through a terminal pursuant to a request by the terminal; sending client authentication information; receiving server authentication information from the server through the terminal; and receiving one of a payment approval message and a payment failure message from the server.

The method further may further comprise sending payment information in a payload with the card identification information to the server.

The method may further comprise sending a payment request containing payment information to the server through the terminal, wherein payment approval is determined based on the payment information contained in the payment request.

The electronic card and the server may authenticate each other by capsulizing information sent and received for authentication based on a protocol that is unknown to the terminal.

Each of the server authentication information and the client authentication information may be generated using at least one from among a certificate and a key.

### BRIEF DESCRIPTION OF THE DRAWINGS

FIG. 1 is a block diagram illustrating a configuration of a system of payment through mutual authentication between an electronic card and a payment server.

FIG. 2 illustrates an internal configuration of a merchant terminal.

FIG. 3 is a block diagram illustrating an internal configuration of an electronic card carrying out payment through mutual authentication with a payment server.

FIG. 4 illustrates the electronic card being coupled to a user terminal.

FIG. 5 is a flow diagram illustrating an electronic payment process in accordance with an exemplary embodiment.

FIG. 6 is a flow diagram illustrating an electronic payment process in accordance with another exemplary embodiment.

FIG. 7 is a flow diagram illustrating an electronic payment process in accordance with yet another exemplary embodiment.

FIG. 8 is a flow diagram illustrating an electronic payment process in accordance with still another exemplary embodiment.

### DETAILED DESCRIPTION

Since there can be a variety of permutations and exemplary embodiments, certain exemplary embodiments will be illustrated and described with reference to the accompanying drawings. This, however, is by no means to restrict the present invention to certain exemplary embodiments, and shall be construed as including all permutations, equivalents and substitutes covered by the ideas and scope of the exemplary embodiments. Throughout the description of the exemplary embodiments, when describing a certain technology is determined to evade the point of the exemplary embodiments, the pertinent detailed description will be omitted.

Terms such as “first” and “second” can be used in describing various elements, but the above elements shall not be restricted to the above terms. The above terms are used only to distinguish one element from the other.

The terms used in the description are intended to describe certain exemplary embodiments only, and shall by no means restrict the present invention. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, certain exemplary embodiments will be described with reference to the accompanying drawings.

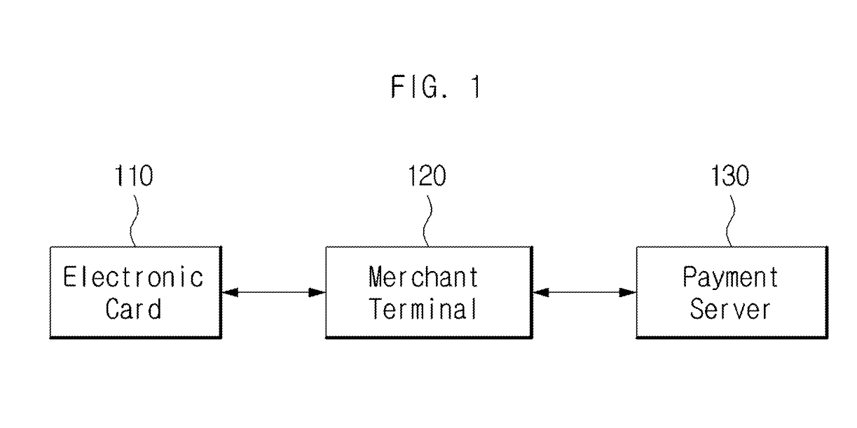

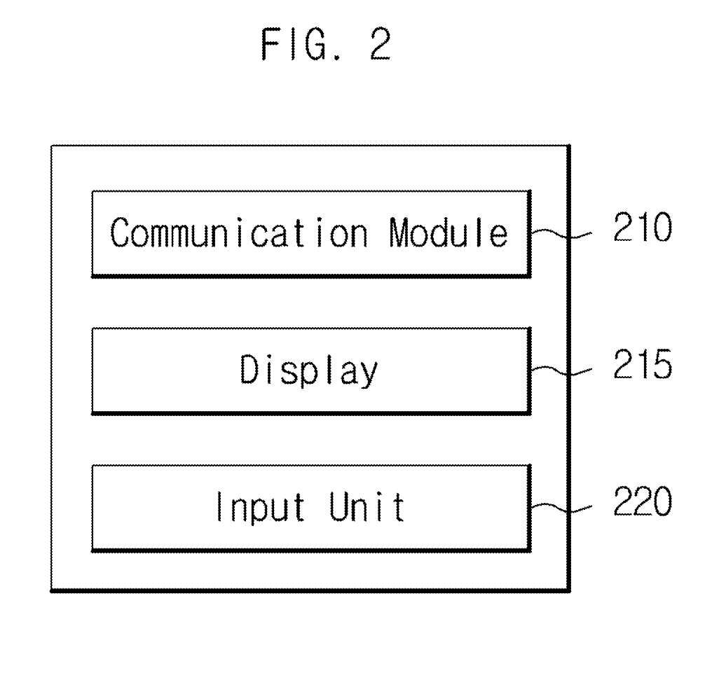

FIG. 1 is a block diagram illustrating a configuration of a system of payment through mutual authentication between an electronic card and a payment server, and FIG. 2 illustrates an internal configuration of a merchant terminal.

Referring to FIG. 1, the payment system is comprised of an electronic card 110, a merchant terminal 120 and a payment server 130. Although not illustrated in FIG. 1, the payment system in accordance with an exemplary embodiment can be placed in between a merchant terminal and a payment server and linked with a card payment proxy system that mediates authentication and payment in a proxy form.

The electronic card 110, which has a short-range communication module therein, is a device for carrying out a payment process through mutual authentication with the payment server 130. Prior to being used for payment, the electronic card 110 can access the payment server 130 to pre-register card identification information required for authentication of the electronic card 110 and store the card identification information in an internal storage space of the electronic card 110, and then authentication can be requested with the payment server 110 by using the card identification information. Here, the card identification information can be a card ID which a user has been issued after having requested registration while communicating with the electronic card 110 through the payment server 130.

Moreover, the electronic card 110, which stores a client certificate, a shared secret key, etc. that are issued through an authentication organization (not shown), can use the stored client certificate, shared secret key, etc. to be linked with the payment server 130 and carry out authentication for the user.

Operations of the electronic card 110 will be described in more detail later with reference to the relevant drawings.

The merchant terminal 120, which has a short-range wireless communication module and a long-range wired/wireless communication module therein, may mediate procedures for payment between the electronic card 110 and the payment server 130.

For example, the merchant terminal 120 can send and receive data to and from the electronic card 110 through short-range wireless communication and send and receive data to and from the payment server 130 through long-range wireless communication (e.g., mobile communication).

In the case that the electronic card 110 does not have a separate input means for inputting data and a display means for displaying data in the form of visual information, the electronic card 110 can be connected with the merchant terminal 120 to input a personal identification number (PIN) and verify the PIN through the merchant terminal 120.

The merchant terminal 120 can mediate authentication and payment information in between the electronic card 110 and the payment server 130 for making a payment between the electronic card 110 and the payment server 130. Here, each of the authentication and payment information is encoded in an authentication method that is agreed between the electronic card 110 and the payment server 130, and thus the merchant terminal 120 is not able to decipher the authentication and payment information.

As illustrated in FIG. 2, the merchant terminal 120 is connected with the electronic card 110 through short-range wireless communication and can communicate with the payment server 130 through long-range communication. Accordingly, the merchant terminal 120 can mediate the communication of data when the data required for mutual authentication between the electronic card 110 and the payment server 130 or for authentication of the electronic card 110 by the payment server is sent and received. This will be described in more detail later with reference to the relevant drawings.

Moreover, the merchant terminal 120 includes a communication module 210, a display 215 and an input unit 220. The communication module 210 includes a plurality of communication units, any one of which is for short-range wireless communication with the electronic card 110 and another of which is for long-range communication with the payment server 130.

The display 215 may display payment information, details of payment approval, etc. in the form of visual information. The display 215 can be, for example, an LCD (liquid crystal display).

A user may input payment-related information via the input unit 220. The input unit 220 can be, for example, a touch panel or key buttons.

The payment server 130 is a device for approving a payment corresponding to the electronic card 110.

For example, the payment server 130 has credit card information stored therein corresponding to the card identification information of the electronic card 110. Moreover, the payment server 130 can obtain authentication information generated through cryptologic operations using a client certificate and a shared secret key from the electronic card 110 through the merchant terminal 120, and can determine whether the payment is to be approved after performing authentication of the user by use of the authentication information. Hereinafter, operations of the payment server 130 will be described in more detail later with reference to the relevant drawings.

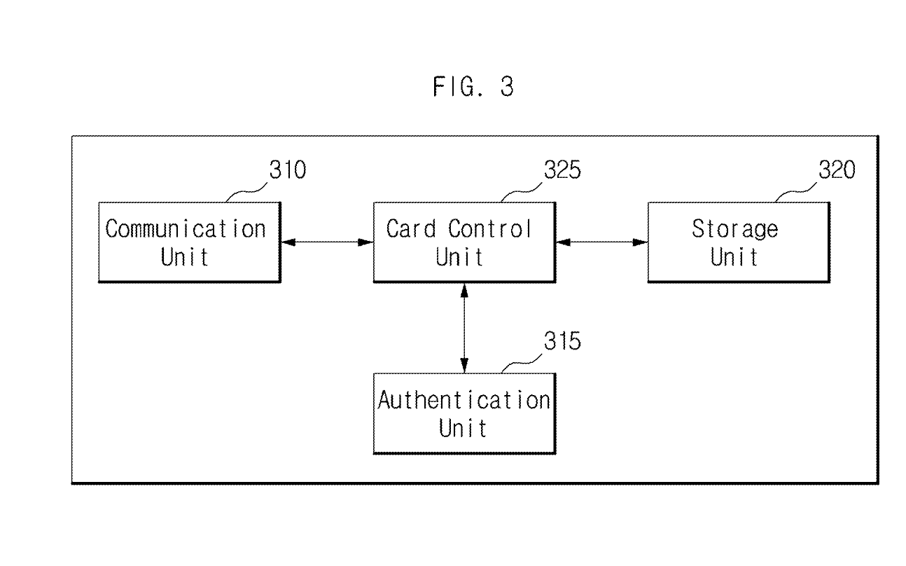

FIG. 3 is a block diagram illustrating an internal configuration of an electronic card carrying out payment through mutual authentication with a payment server.

The electronic card 110 in accordance with an exemplary embodiment comprises a communication unit 310, an authentication unit 315, a storage unit 320 and a card control unit 325. The communication unit 310, authentication unit 315, storage unit 320, and card control unit 325 may be implemented by a hardware component, a software module, or a combination of both.

The communication unit 310 may send and receive data to and from other devices (e.g., the merchant terminal) through a communication network.

The authentication unit 315 may authenticate the payment server 130 or obtain an authentication result value by use of a shared secret key. This will be described later in more detail.

The storage unit 320 stores card authentication information, a shared secret key, card identification information, and the like. It shall be also appreciated that the storage unit 320 has a variety of algorithms stored therein for operating the electronic card 110.

The card control unit 325 may control internal elements (e.g., the communication unit 310, the authentication unit 315, the storage unit 320, etc.) of the electronic card 110 in accordance with an exemplary embodiment.

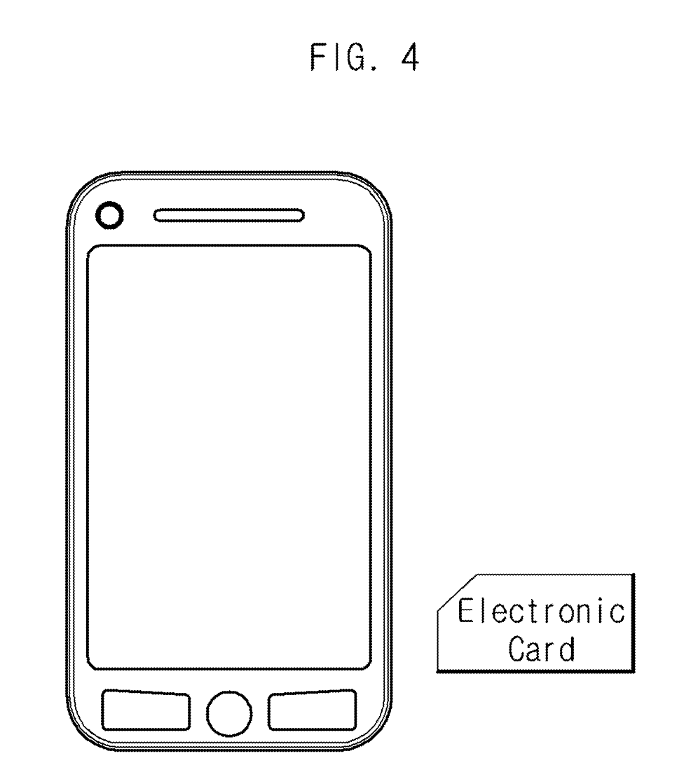

FIG. 4 illustrates the electronic card being coupled to a user terminal.

As illustrated in FIG. 4, the electronic card 110 can be physically coupled to a user terminal. Accordingly, the electronic card 110 can have the PIN inputted by the user or inquire about the details of payment approval in real time through input means and output means of the user terminal. Although the physical form of electronic card 110 is described herein for the convenience of description and understanding, the electronic card can be realized in the form of a software module of the user terminal that supports short-range communication.

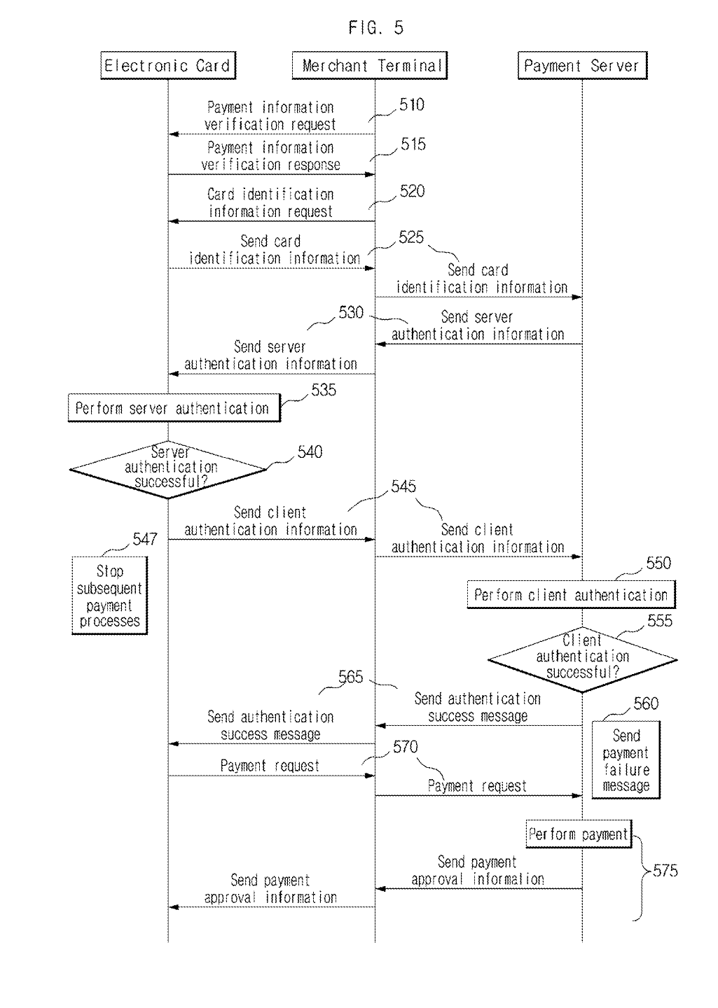

FIG. 5 is a flow diagram illustrating an electronic payment process in accordance with an exemplary embodiment.

In step 510, the merchant terminal 120 can sent a payment information verification request, which includes payment information, to the electronic card 110. Here, the payment information can be at least one from among payment amount, payment currency information, installment information and merchant information. It shall be appreciated that the payment information can also include various kinds of information required for actual payment.

In step 515, the electronic card 110 can send a payment information verification response to the merchant terminal 120. Upon receiving the payment information verification response of the electronic card 110, the merchant terminal 120 can send a card identification information request for the electronic card 110 to the electronic card 110 (step 520) in order to carry out payment procedures. Depending on how it is realized, the merchant terminal 120 can send the card identification information request of the electronic card 110 to the electronic card 110 when a payment process start request is made by the electronic card 110.

As described above, the card identification information includes the card ID that is registered by the user through the payment server 130, in addition to the card information for the electronic card 110. It is possible to verify the card information, such as a card number, with the card ID only.

In step 525, the merchant terminal 120 obtains the card identification information from the electronic card 110 and sends the obtained card identification information to the payment server 130. Once the card identification information request is received through the merchant terminal 120, the electronic card 110 can further carry out a procedure for having the PIN inputted by the user, before sending the card identification information to the payment server 130 through the merchant terminal 120.

By adding the step of inputting the PIN, it is possible to prevent any malicious use of the electronic card 110.

In step 530, the payment server 130 primarily capsulizes server authentication information required for authentication of the payment server 130 to a first authentication protocol, then secondarily capsulizes the primarily-capsulized server authentication information to a second authentication protocol, and, finally, sends the capsulized server authentication information to the electronic card 110 through the merchant terminal 120.

In this specification, the payment server 130 and the electronic card 110 send and receive information required for authentication to and from each other by capsulizing the information to the first authentication protocol, and the electronic card 110 and the merchant terminal 120 send and receive information required for authentication to and from each other by capsulizing the information to the second authentication protocol.

In this way, even if the payment server 130 sends the server authentication information through the merchant terminal 120, the merchant terminal 120 is not able to decipher the secondarily-capsulized server authentication information.

In step 535, the electronic card 110 deciphers the secondarily-capsulized server authentication information and obtains the server authentication information, and carries out server authentication for the payment server 130 by using the server authentication information.

Then, in step 540, the electronic card 110 determines whether the server authentication is successful.

If the server authentication has been successful, the electronic card 110 secondarily capsulizes and sends client authentication information to the payment server 130 through the merchant terminal 120, in step 545.

However, if the server authentication has failed, the electronic card 110 stops subsequent processes for payment due to the failure of authentication for the payment server 130, in step 547. Here, the electronic card 110 can output a message corresponding to the authentication failure through the user terminal to which the electronic card is connected or coupled. It is also possible that the message corresponding to payment failure subsequent to the authentication failure is sent to the merchant terminal 120.

In step 550, the payment server 130 authenticates the client, i.e., the electronic card, by use of the secondarily-capsulized client authentication information.

In step 555, the payment server 130 checks whether the client is successfully authenticated.

If client authentication is failed, the payment server 130 sends a client authentication failure message, which includes a pre-stored failure code and failure cause information, corresponding to the failure of client authentication to the electronic card 110 through the merchant terminal 120, in step 560.

However, if the client authentication is successful, the payment server 130 sends a client authentication success message to the electronic card 110 through the merchant terminal 120, in step 565.

Accordingly, in step 570, the electronic card 110 sends a payment request, which includes the payment information, to the payment server 130 through the merchant terminal 120.

In step 575, the payment server 130 approves the payment corresponding to the payment information included in the payment request and then sends payment approval confirmation to the electronic card 110 through the merchant terminal 120.

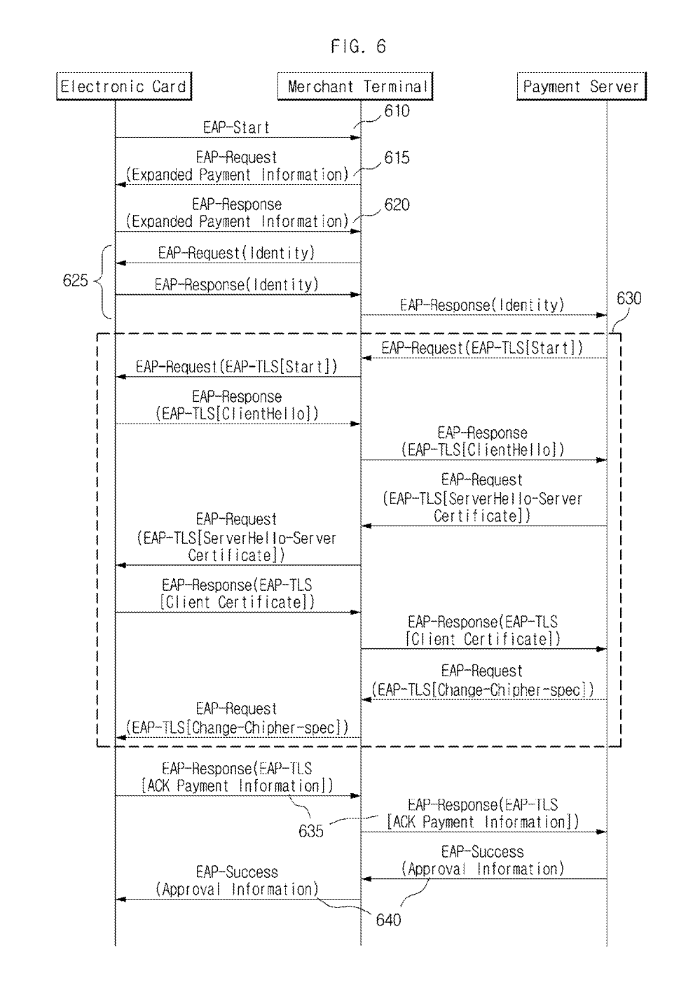

FIG. 6 is a flow diagram illustrating an electronic payment process in accordance with another exemplary embodiment.

In FIG. 6, the electronic card 100 and the payment server 130 in the electronic payment process shown in FIG. 5 are mutually authenticated using an extensible authentication protocol-transport layer security (EAP-TLS) authentication method.

In step 610, the electronic card 110 sends an EAP-Start message to the merchant terminal 120 in order to start the electronic payment process. The EAP-Start message can be optionally sent from the electronic card 110 to the merchant terminal 120, and can be omitted, depending on how the exemplary embodiment is implemented.

In step 615, the merchant terminal 120 sends an EAP-Request message, which includes the payment information, to the electronic card 110.

Then, in step 620, the electronic card 110 sends an EAP-Response message, which includes the payment information, to the merchant terminal 120. Accordingly, the merchant terminal 120 can verify that the electronic card 110 has received the EAP-Request message for payment request.

Accordingly, in step 625, the merchant terminal 120 sends an EAP-Request (Identity) for requesting the card identification information of the electronic card 110 to the electronic card 110, and in response to this, the electronic card 110 sends an EAP-Response (Identity) including the card identification information to the payment server 130 through the merchant terminal 120.

Then, in step 630, the electronic card 110 and the payment server 130 mutually sends their respective authentication information and perform mutual authentication.

Here, the merchant terminal 120 plays the role of a messenger that mediates a message required for mutual authentication between the electronic card 110 and the payment server 130, and the message sent and received in the mutual authentication process between the electronic card 110 and the payment server 130 can be capsulized to a separate authentication protocol (e.g., EAP TLS) so that the content of the message may not be deciphered. Moreover, only a result of cryptologic calculation of core information required for mutual authentication between the electronic card 110 and the payment server 130 can be sent and received so that original information (plain text) of the pertinent information may not be decoded even if the capsulized message is deciphered by the merchant terminal 120.

Accordingly, it is not possible for the merchant terminal 120 to decipher the message normally sent and received between the electronic card 110 and the payment server 130 for mutual authentication.

Once the mutual transfer of the authentication information and the mutual authentication are completed; that is, when authentication success for the electronic card 110 is received from the payment server 130 while authentication for the payment server 130 is performed by the electronic card 110 and the authentication is successful, the electronic card 110 piggybacks the payment information in an ACK message, which is an EAP-TLS completion message, and sends the piggybacked payment information to the payment server 130 through the merchant terminal 120, in step 635.

Accordingly, in step 640, payment approval is carried out using the payment information, and an approval number and payment information pursuant to the payment approval are included in an EAP-Success message and sent to the electronic card 110 through the merchant terminal 120.

Although the merchant terminal 120 was not able to decipher the message that is capsulized one more time to a protocol that is not known in the mutual authentication process between the electronic card 110 and the payment server 130, the merchant terminal 120 can properly decipher the EAP-Success message pursuant to the payment approval and output the approval information through a display that is connected to the merchant terminal 120.

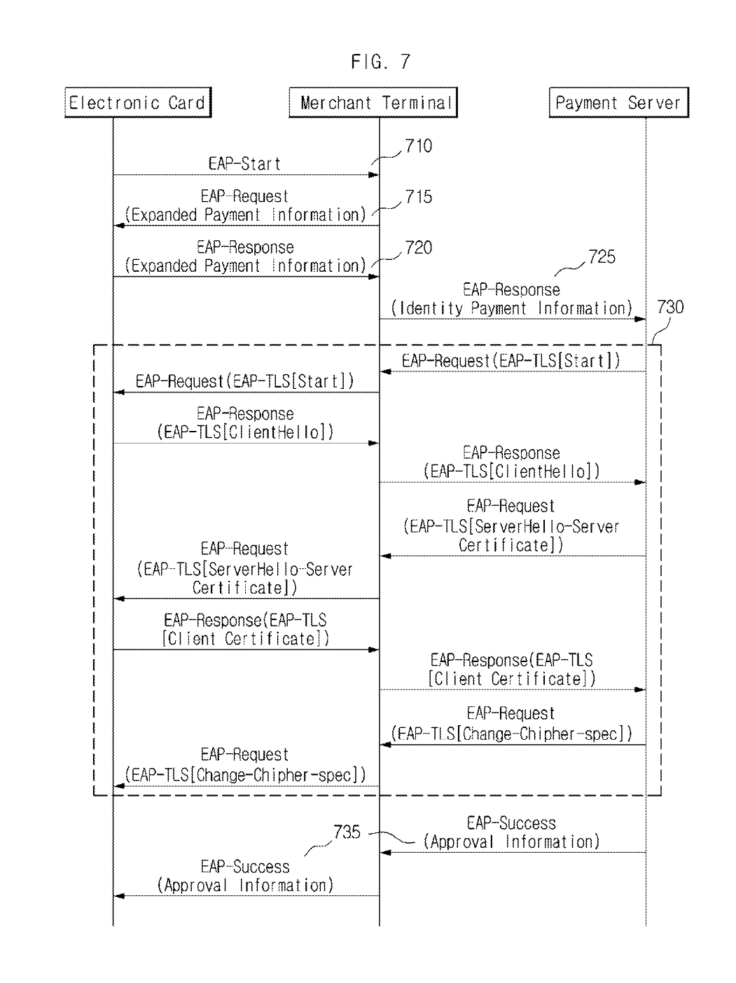

FIG. 7 is a flow diagram illustrating an electronic payment process in accordance with yet another exemplary embodiment.

Shown in FIG. 7 is an EAP-TLS authentication method that modifies and utilizes an EAP message.

In FIG. 7, the description for steps that are identical to FIG. 6 will be omitted, and steps that are different from FIG. 6 will be only described.

As shown in FIG. 710, after an EAP-Start message for starting electronic payment is sent to the merchant terminal 120 from the electronic card 110, the merchant terminal 120 can send an EAP-Request (Identity) message for requesting the card identification information and at the same time send the payment information to the electronic card 110 by piggybacking the payment information in a payload (step 715).

Then, in step 720, the electronic card 110 sends a piggybacked EAP-Response (Identity) message to the merchant terminal 120, and the merchant terminal 120 transfers the EAP-Response (Identity) message to the payment server 130. Accordingly, before performing authentication based on the card identification information, the payment server 130 temporarily stores the piggybacked and transferred payment information and then prepares for actual authentication (step 725).

Subsequent steps are identical to those of FIG. 6 and thus will not be described herein.

However, when sending an EAP-Success message to the merchant terminal 120 after mutual authentication is completed, the payment server 130 can piggyback and send the payment information to allow the merchant terminal 120 to verify normal approval.

It is also possible that when sending an EAP-Failure message to the merchant terminal 120, the payment server 130 can include and send a failure code and failure cause information to allow the merchant terminal 120 to verify the cause of failure.

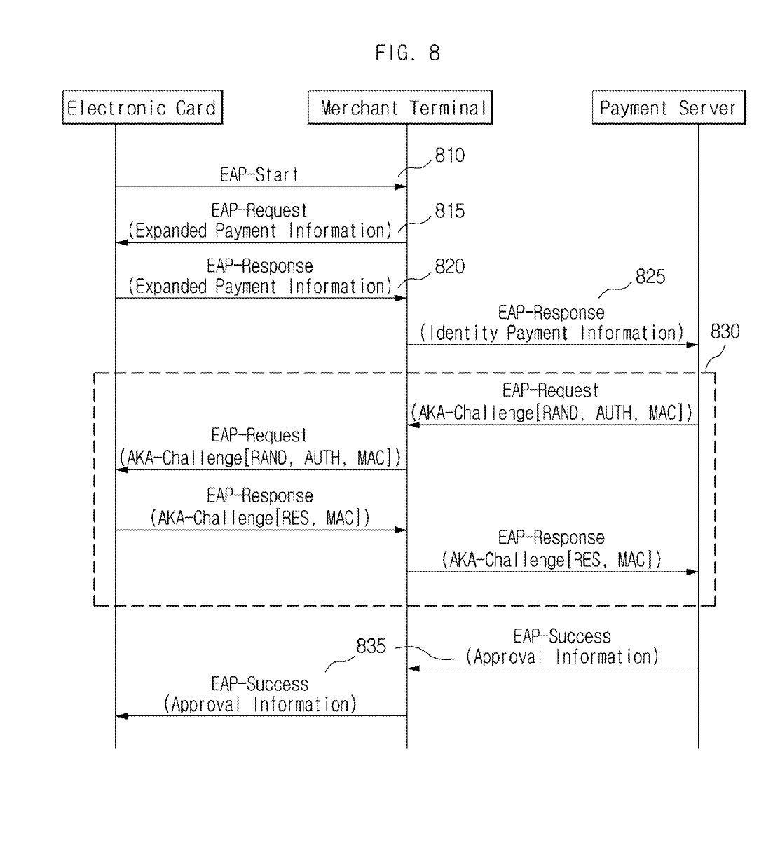

FIG. 8 is a flow diagram illustrating an electronic payment process in accordance with still another exemplary embodiment.

While FIG. 6 and FIG. 7 illustrate EAP-TLS based mutual authentication between the electronic card 110 and the payment server 130, the EAP-TLS based authentication is possible only if the electronic card 110 and the payment server 130 have a certificate installed therein. Accordingly, when the electronic card 110 and the payment server 130 are mutually authenticated, EAP-tunneled transport layer security (EAP-TTLS), EAP for Universal Mobile Telecommunications System (UMTS) Authentication and Key Agreement (EAP-AKA) and EAP for Global System for Mobile Communications (GSM) Subscriber Identity Module (EAP-SIM) authentication methods can be used, without using a certificate.

Illustrated in FIG. 8 is a method of mutually authenticating the electronic card 110 and the payment server 130 by use of the EAP-AKA authentication method.

The EAP-AKA authentication method uses a shared secret key (K, OPc) for mutual authentication between the electronic card 110 and the payment server 130. Such a shared secret key is not shown through the display unit of the user terminal so that it becomes impossible to inquire, input and/or delete the shared secret key through the user terminal.

Steps 810 to 825 are identical to steps 710 to 725 in FIG. 7 and thus will not be described herein.

In step 830, the payment server 130 sends an EAP-Request message, which includes authentication information for authenticating the electronic card 110, to the electronic card 110 through the merchant terminal 120.

Subsequently, in step 835, the electronic card 110 obtains an authentication result value based on the authentication information by use of the authentication information and the shared secret key and sends the obtained authentication result value to the payment server 130 through the merchant terminal 120. Accordingly, the payment server 130 can check whether the authentication has been successful by comparing the authentication result value received through the electronic card 110 with a pre-stored authentication result value. Subsequent steps are identical to those of FIG. 7 and thus will not be described herein.

Although EAP authentication for an electronic card has been described for the convenience of description and understanding, it is also possible to carry out communication between a merchant terminal and a payment server by use of a separate protocol, such as RADIUS, DIAMETER and the like. As such, by using the protocol of EAP and RADIUS/DIAMETER, etc., it is not necessary to modify the merchant terminal due to future addition of a new EAP authentication protocol, making it easy to provide additional security.

The method for providing information in accordance with an exemplary embodiment can be embodied in the form of program instructions, which can be performed through various electronic data processing means, and can be written in a storage medium, which can include program instructions, data files, data structures and the combination thereof.

The program instructions stored in the storage medium can be designed and configured specifically for exemplary embodiments or can be publically known and available to those who are skilled in the field of software. Examples of the storage medium can include magnetic media, such as a hard disk, a floppy disk and a magnetic tape, optical media, such as compact disc-read only memory (CD-ROM) and digital versatile disc (DVD), magneto-optical media, such as a floptical disk, and hardware devices, such as ROM, random access memory (RAM) and flash memory, which are specifically configured to store and run program instructions. Moreover, the above-described media can be transmission media, such as optical or metal lines and a waveguide, which include a carrier wave that transmits a signal designating program instructions, data structures, etc. Examples of the program instructions can include machine codes made by, for example, a compiler, as well as high-language codes that can be executed by an electronic data processing device, for example, a computer, by using an interpreter.

The above hardware devices can be configured to operate as one or more software modules in order to perform the operation of exemplary embodiments, and the opposite is also possible.

Although some exemplary embodiments have been described above, it shall be appreciated that there can be a variety of permutations and modifications of exemplary embodiments by those who are ordinarily skilled in the art to which the present invention pertains without departing from the technical ideas and scope of the present invention, which shall be defined by the appended claims.

What is claimed is:

1. A payment system, comprising:
an electronic card which obtains server authentication information from a first server, to perform server authentication based on the obtained server authentication information, and sends a payment request including payment information to the first server according to an authentication response of the first server;
a terminal which receives and transmits a message for authentication and payment between the electronic card and the first server; and
the first server which is configured to perform client authentication by obtaining client authentication information from the electronic card according to the server authentication and send the authentication response to the electronic card, and configured to send payment approval pursuant to the payment request to the electronic card through the terminal.

2. The payment system of claim 1, wherein the server authentication information is at least one from among a server certificate and a first key for authentication of the first server, and
wherein the client authentication information is authentication information generated using at least one from among a client certificate and a second key issued through one of the first server and a second server of an agency for authentication of the electronic card.

3. The payment system of claim 1, wherein the electronic card and the first server are configured to authenticate each other by capsulizing the server authentication information and the client authentication information based on an authentication protocol that is unknown to the terminal for mutual authentication and sending the capsulized server authentication information and client authentication information through the terminal.

4. The payment system of claim 3, wherein the electronic card sends card identification information to the first server through the terminal according to a request of the terminal, prior to the mutual authentication.

5. The payment system of claim 4, wherein the card identification information is not a card number of the electronic card.

6. A method of electronic payment in a payment system, the method comprising:
sending card identification information to a server through a terminal pursuant to a request by the terminal, the card identification information being sent by an electronic card;
sending server authentication information to the electronic card through the terminal pursuant to receiving the card identification information and performing client authentication by obtaining client authentication information from the electronic card, the server authentication information being sent and the client authentication being performed by the server; and
if the client authentication is successful, performing a payment process and sending one of a payment approval message and a payment failure message to the electronic card through the terminal, the payment process being performed and the one of the payment approval message and the failure message being sent by the server.

7. The method of claim 6, wherein the electronic card sends payment information in a payload when the electronic card sends the card identification information to the server.

8. The method of claim 6, further comprising, after the performing the client authentication by the server, sending a payment request containing payment information to the server through the terminal, the payment request being sent by the electronic card,
wherein payment approval is determined based on the payment information contained in the payment request, when electronic payment is carried out by the server.

9. The method of claim 6, wherein the electronic card and the server authenticate each other by capsulizing information sent and received for authentication based on a protocol that is unknown to the terminal.

10. The method of claim 6, wherein each of the server authentication information and the client authentication information is generated using at least one from among a certificate and a key.

11. A method of electronic payment in a payment system, the method comprising:
receiving, at a server, card identification information through a terminal pursuant to a request by the terminal, the card identification information being sent by an electronic card;
sending server authentication information to the electronic card through the terminal pursuant to receiving the card identification information and performing client authentication by obtaining client authentication information from the electronic card; and
if the client authentication is successful, performing a payment process and sending one of a payment approval message and a payment failure message to the electronic card through the terminal.

12. The method of claim 11, wherein the server receives payment information in a payload with the card identification information, from the electronic card.

13. The method of claim 11, further comprising, after the performing of the client authentication, receiving a payment request containing payment information, wherein payment approval is determined based on the payment information contained in the payment request.

14. The method of claim 11, wherein the electronic card and the server authenticate each other by capsulizing information sent and received for authentication based on a protocol that is unknown to the terminal.

15. The method of claim 11, wherein each of the server authentication information and the client authentication information is generated using at least one from among a certificate and a key.

16. A method of electronic payment in a payment system, the method comprising:
sending, by an electronic card, card identification information to a server through a terminal pursuant to a request by the terminal;
sending client authentication information;
receiving server authentication information from the server through the terminal; and
receiving one of a payment approval message and a payment failure message from the server.

17. The method of claim 16, further comprising sending payment information in a payload with the card identification information to the server.

18. The method of claim 16, further comprising, sending a payment request containing payment information to the server through the terminal,
wherein payment approval is determined based on the payment information contained in the payment request.

19. The method of claim 16, wherein the electronic card and the server authenticate each other by capsulizing information sent and received for authentication based on a protocol that is unknown to the terminal.

20. The method of claim 16, wherein each of the server authentication information and the client authentication information is generated using at least one from among a certificate and a key.
